(19) United States
(12) Patent Application Publication
(10) Pub. No.: US 2026/0064602 A1
(43) Pub. Date: Mar. 5, 2026

(54) DATA PROCESSING DEVICE AND DATA PROCESSING SYSTEM

(71) Applicant: SK hynix Inc., Icheon-si (KR)

(72) Inventors: Myoung Seo KIM, San Jose, CA (US); Ho Shik KIM, San Jose, CA (US)

(21) Appl. No.: 19/087,093

(22) Filed: Mar. 21, 2025

Related U.S. Application Data
(60) Provisional application No. 63/691,268, filed on Sep. 5, 2024.

(30) Foreign Application Priority Data
Nov. 29, 2024 (KR) 10-2024-0174373

(51) Int. Cl. G06F 12/1081; G06F 13/16; G06F 13/40

(52) U.S. Cl. CPC G06F 12/1081; G06F 13/1668; G06F 13/4068

(57) ABSTRACT

An input/output unit communicates with a memory located outside a data processing device to provide a sub-processing function to perform data processing using a memory located inside the data processing device and a memory located outside the data processing device. Delay due to access to the memory located outside the data processing device by a processing unit of the data processing device may be reduced, and processing performance by the data processing device may be improved.

### CROSS-REFERENCE TO RELATED APPLICATION

The present application claims priority under 35 U.S.C. 119 to U.S. Provisional Patent Application No. 63/691,268 filed on Sep. 5, 2024, and Korea Patent Application No. 10-2024-0174373 filed on Nov. 29, 2024, which is incorporated herein by reference in its entirety.

### BACKGROUND

### 1. Technical Field

Embodiments of the present disclosure generally relate to a data processing device and a data processing system.

### 2. Related Art

A data processing device may include at least one processor that performs calculations for data processing. In addition, the data processing device may include at least one memory for storing data for data processing performed by the processor.

For example, the data processing device may perform data processing using a memory that is located inside the data processing device. Sometimes, the data processing device may perform data processing using a memory that is located outside of the data processing device.

When using a memory located inside a data processing device, the performance of data processing may be improved, but there may be limitations in increasing the capacity of a memory located inside the data processing device.

### SUMMARY

Various embodiments of the present disclosure are directed to providing measures capable of allowing a data processing device to perform data processing using both a memory located inside the data processing device and a memory located outside the data processing device to improve the performance of data processing.

In an embodiment, a data processing device may include: a first memory; a processing unit configured to communicate with the first memory through a first signal line, and to perform first data processing using the first memory and an external second memory; and an input/output unit configured to communicate with the first memory through a second signal line, to transfer data that is transmitted and received between the processing unit and the external second memory, and to perform second data processing using at least one of the first memory or the external second memory.

In an embodiment, a data processing system may include: an external memory disposed on a substrate; and a data processing chip disposed on the substrate, and configured to communicate with the external memory, the data processing chip including: an internal memory; a processing unit configured to perform first data processing using the internal memory and the external memory; and an input/output unit configured to transfer data to be transmitted and received between the processing unit and the external memory, and to perform second data processing using at least one of the internal memory or the external memory.

In an embodiment, a data processing system may include: an external memory disposed on a substrate; and a data processing chip disposed on the substrate, and configured to communicate with the external memory, the data processing chip including: an internal memory; a processing unit configured to communicate with the internal memory, and to perform first data processing using the internal memory and the external memory; and an input/output unit configured to transfer data, to be transmitted and received between the processing unit and the external memory through a first external signal line, and perform second data processing while transmitting and receiving data to and from the external memory through a second external signal line.

According to the embodiments of the present disclosure, it is possible to provide measures capable of improving the performance of data processing performed using a memory located inside a data processing device and a memory located outside the data processing device and capable of maintaining and managing consistency according to data processing.

### BRIEF DESCRIPTION OF THE DRAWINGS

FIG. 1 is a schematic illustration of a data processing system according to embodiments of the present disclosure.

FIG. 2 is a schematic illustration of another data processing system according to embodiments of the present disclosure.

FIG. 3 is a diagram illustrating an example of a configuration of a processing unit included in a data processing device of a data processing system according to embodiments of the present disclosure.

FIG. 4 is a diagram illustrating an example of a configuration of an input/output unit included in a data processing device of a data processing system according to embodiments of the present disclosure.

FIG. 5 is a diagram illustrating an example in which a data processing system performs data processing according to embodiments of the present disclosure.

FIG. 6 is a diagram illustrating another example of a configuration of a data processing system according to embodiments of the present disclosure.

FIG. 7 is a diagram illustrating an example in which a processing unit of a data processing system performs data processing according to embodiments of the present disclosure.

FIG. 8 is a diagram illustrating an example in which an input/output unit of a data processing system performs data processing according to embodiments of the present disclosure.

FIG. 9 and FIG. 10 are diagrams illustrating examples of a data processing system according to embodiments of the present disclosure performs data processing.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings. Further, in the following description of examples or embodiments of the present disclosure, detailed descriptions of well-known functions and components incorporated herein will be omitted when it is determined that the description may make the subject matter in some embodiments of the present disclosure more unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, or manufacturing methods, these terms may be used to describe non-consecutive or non-sequential processes or operations unless the term “directly” or “immediately” is used together.

In addition, when any dimensions, relative sizes etc. are mentioned, it should be considered that numerical values for elements or features, or corresponding information (e.g., level, range, etc.) include a tolerance range or error margin that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to accompanying drawings.

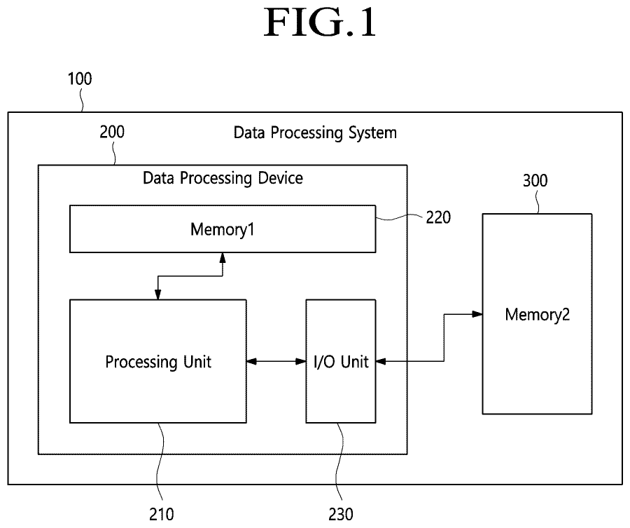

FIG. 1 is a schematic illustration of a data processing system according to embodiments of the present disclosure.

Referring to FIG. 1, a data processing system 100 may include a data processing device 200 that performs data processing. The data processing device 200 may be implemented by a semiconductor chip, and in the present specification, the data processing device 200 may be referred to as a data processing chip.

The data processing device 200 may be disposed on a substrate, for example, such as a printed circuit board. At least one second memory Memory2 300, which is located outside the data processing device 200, may be disposed on the substrate. The second memory 300 may be, for example, a volatile memory such as a DRAM, but embodiments are not limited thereto. In the present specification, the second memory 300 may be referred to as an external memory that is external to the data processing device 200.

The data processing device 200 may perform data processing using an external memory such as the second memory 300.

In addition, the data processing device 200 may perform data processing using a memory that is located inside the data processing device 200.

The data processing device 200 may include, for example, a processing unit 210. The processing unit 210 may be, for example, a processor such as a CPU or a GPU.

The data processing device 200 may include a first memory Memory1 220. The first memory 220 may be, for example, a volatile memory such as a DRAM or may be a high-performance volatile memory, such as an HBM (High Bandwidth Memory), which provides fast speed and large capacity, but is not limited thereto. In the present specification, the first memory 220 may be referred to as an internal memory.

The data processing device 200 may include an input/output unit I/O Unit 230. The input/output unit 230 may transfer data to be transmitted and received between the processing unit 210 located inside the data processing device 200 and the second memory 300 located outside the data processing device 200.

The input/output unit 230 may be, for example, an optical input/output chiplet that provides fast data transmission speed with high density, but embodiments are not limited thereto. In some embodiments, each of the processing unit 210, the first memory 220 and the input/output unit 230 included in the data processing device 200 may be implemented in the form of a chiplet. The data processing device 200 may be configured by combining a first chiplet that performs a processing function, a second chiplet that performs a data storage function and a third chiplet that performs a data transmission/reception function.

The processing unit 210 of the data processing device 200 may perform data processing while communicating with the first memory 220, which is located inside the data processing device 200.

By performing data processing using the first memory 220, which is located inside the data processing device 200, the processing unit 210 may provide rapid data processing performance.

The processing unit 210 may perform data processing while communicating, through the input/output unit 230, with the second memory 300, which is external to the data processing device 200.

By performing data processing while communicating with the second memory 300 through the input/output unit 230, the processing unit 210 may provide improved data processing performance compared to a device that performs data processing using only the first memory 220 located inside the data processing device 200.

When the processing unit 210 performs data processing using the second memory 300 through the input/output unit 230, a command, an address and so on that is output by the processing unit 210 may be input to the input/output unit 230.

The input/output unit 230 may transfer the received command, address and so on to the second memory 300, and may receive data corresponding to the command and address from the second memory 300. The input/output unit 230 may transfer the data received from the second memory 300 to the processing unit 210.

Data processing is performed while data is transmitted and received by the input/output unit 230, which can provide faster transmission speeds, and data processing is performed without being limited to the capacity of the first memory 220, which is located inside the data processing device 200. Therefore, the data processing performance of the data processing device 200 may be improved.

In addition, embodiments of the present disclosure may provide measures capable of improving data processing performance by further reducing delay time for data processing performed while data is transmitted and received through the input/output unit 230.

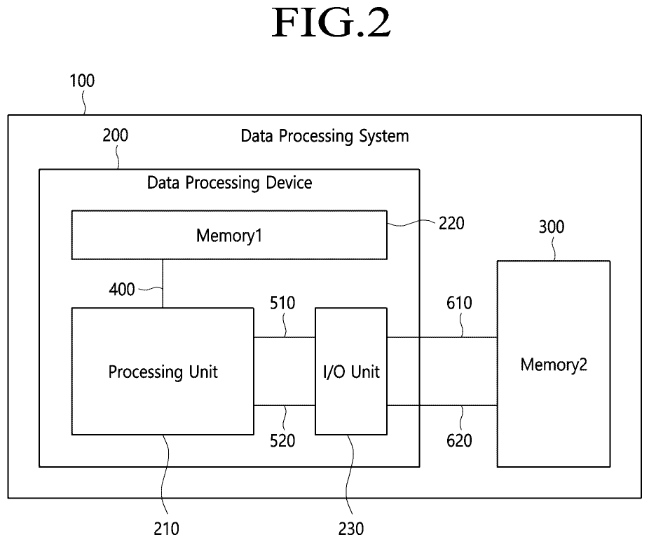

FIG. 2 is a schematic illustration of another data processing system according to embodiments of the present disclosure.

Referring to FIG. 2, a data processing system 100 may include a data processing device 200 and a second memory 300. The data processing device 200 and the second memory 300 may be disposed on a substrate such as a printed circuit board.

The data processing device 200 may include a processing unit 210, a first memory 220 and an input/output unit 230.

The processing unit 210 may perform data processing using the first memory 220 and the second memory 300. The processing unit 210 may communicate with the first memory 220, for example, through an internal signal line 400. The processing unit 210 may perform data processing while transmitting and receiving data to and from the first memory 220 through the internal signal line 400. In some embodiments, the internal signal line 400 may be composed of at least two lines, and, for example, a line through which a command is transmitted and a line through which data is transmitted may be separated.

The first memory 220 may be a volatile memory such as a DRAM or an HBM, but embodiments are not limited thereto. The first memory 220 may store data while communicating with the processing unit 210 through the above-described internal signal line 400.

The input/output unit 230 may be an optical input/output chiplet. The input/output unit 230 may transfer data that is transmitted and received between the processing unit 210 and the second memory 300.

In addition, the input/output unit 230 may be allocated and perform at least a part of data processing to be performed by the processing unit 210. The input/output unit 230 may perform data processing separately from data processing that is performed by the processing unit 210.

In the present specification, data processing to be performed by the processing unit 210 may be referred to as first data processing, and data processing to be performed by the input/output unit 230 may be referred to as second data processing.

Since the input/output unit 230 provides a data processing function in addition to a data transmission/reception function, delay time is reduced compared to a data processing system where only a processing unit 210 performs data processing while also transmitting and receiving data through the input/output unit 230.

When the input/output unit 230 performs a data processing function, the input/output unit 230 may communicate with other components through a plurality of lines.

For example, the input/output unit 230 may communicate with the processing unit 210 through a data transmission line 510 and a communication line 520.

The data transmission line 510 may be a line for transmitting data that is transmitted and received between the processing unit 210 and the second memory 300. While the processing unit 210 performs data processing using the second memory 300, a command, an address, data and so on to be transmitted and received may be transferred to the input/output unit 230 through the data transmission line 510.

The communication line 520 may be a line for transmitting related information according to data processing of the processing unit 210 and the input/output unit 230.

For example, the processing unit 210 may perform first data processing using the second memory 300. The input/output unit 230 may perform second data processing using the second memory 300.

Data processing may be performed by each of the processing unit 210 and the input/output unit 230, and result data according to the data processing may be stored in the second memory 300. The processing unit 210 and the input/output unit 230 may share, through the communication line 520, data processing content as information related to result data. The information related to the result data can include, for example, information on an address or the like, which may be updated according to data processing.

While data processing is performed by the input/output unit 230, lines through which data is transmitted and received between the input/output unit 230 and the second memory 300 may also be separated.

For example, the input/output unit 230 may transmit data that is transmitted and received between the processing unit 210 and the second memory 300 through a first external signal line 610. The input/output unit 230 may transmit data that is transmitted and received, related to second data processing by the input/output unit 230, through a second external signal line 620.

Data according to a first data processing may be transmitted and received through the first external signal line 610, and data according to a second data processing may be transmitted and received through the second external signal line 620.

In some embodiments, data according to the first data processing and data according to the second data processing may be transmitted and received through the same external signal line, and data according to the first data processing and data according to the second data processing may be transmitted and received through an external signal line during separate time periods.

At least a part of data processing to be performed using the second memory 300 may be performed by the input/output unit 230. Since data processing is performed by the input/output unit 230, data processing may be performed while communication between the input/output unit 230 and the second memory 300 is also performed, and during this data processing, communication between the processing unit 210 and the second memory 300 is not performed for the purpose of data processing by the processing unit 210.

Since data processing is performed without transmitting and receiving data to and from the processing unit 210, delay time may be reduced and the performance of data processing may be improved when processing data using the second memory 300, which is located outside the data processing device 200.

When the input/output unit 230 performs data processing, the input/output unit 230 and the processing unit 210 may use configurations to support data processing by the input/output unit 230.

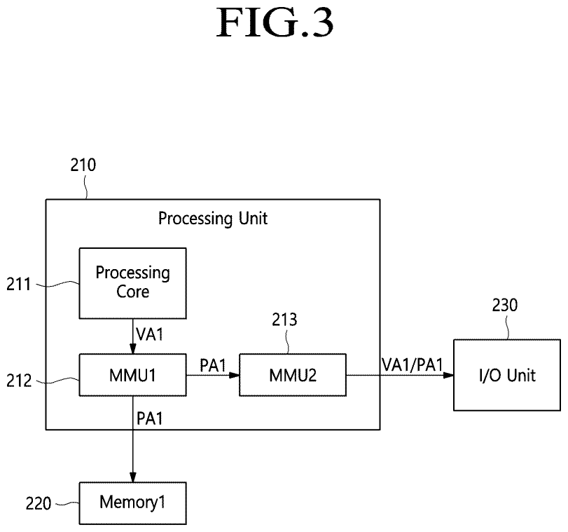

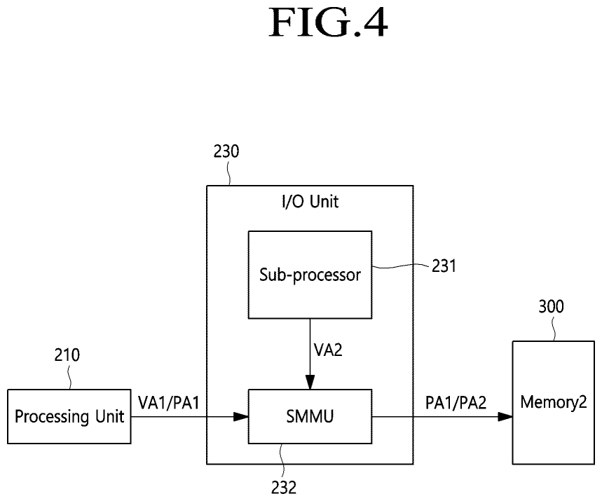

FIG. 3 is a diagram illustrating an example of a configuration of a processing unit included in a data processing device of a data processing system according to embodiments of the present disclosure. FIG. 4 is a diagram illustrating an example of a configuration of an input/output unit included in a data processing device of a data processing system according to embodiments of the present disclosure.

Referring to FIG. 3, a processing unit 210 may include, for example, a processing core 211, a first address translation section MMU1 212 and a second address translation section MMU2 213.

The processing core 211 may perform a calculation and so on according to first data processing by the processing unit 210. In first data processing, the processing core 211 may generate and output a command for storing data in a first memory 220 or a second memory 300, or for reading data written to the first memory 220 or the second memory 300.

The processing core 211 may output, for example, a first virtual address VA1 for writing or reading data to or from a memory. The first virtual address VA1 may mean a logical address that indicates data to be managed by the processing core 211.

The first address translation section 212 may translate the first virtual address VA1 output by the processing core 211 into a first physical address PA1. The first physical address PA1 may mean a physical address that indicates a storage area included in the first memory 220 or the second memory 300.

When performing data processing using the first memory 220, which is located inside the data processing device 200, the processing unit 210 may transmit the first physical address PA1 output by the first address translation section 212 to the first memory 220. An operation on the first memory 220 may be performed using the first physical address PA1 and the command outputted by the processing core 211.

The first physical address PA1 output by the first address translation section 212 may also be transferred to the second address translation section 213. When performing data processing using the second memory 300, which is located outside the data processing device 200, the processing unit 210 may transmit the first physical address PA1 to the input/output unit 230 through the second address translation section 213.

When the processing unit 210 transmits data to the second memory 300 through the input/output unit 230, the second address translation section 213 may transmit the first physical address PA1 to the input/output unit 230. The first physical address PA1 may be transferred to the second memory 300 through the input/output unit 230.

When the processing unit 210 requests data processing by the input/output unit 230, the second address translation section 213 may transmit the first virtual address VA1 to the input/output unit 230. The input/output unit 230 may receive the command and the first virtual address VA1 for data processing from the processing unit 210, and may perform data processing on the basis of received data. The input/output unit 230 may perform data processing while accessing the second memory 300 using a physical address corresponding to the first virtual address VA1 and writing data to the second memory 300 or reading data that is written to the second memory 300.

The input/output unit 230 may perform data processing using a virtual address received from the processing unit 210, or perform data processing using an internally generated virtual address in response to a request for data processing from the processing unit 210.

For example, referring to FIG. 4, the input/output unit 230 may include a sub-processor 231 and a sub-address translation section SMMU 232.

The sub-processor 231 may control second data processing to be performed by the input/output unit 230. The sub-processor 231 may correspond to the processing core 211 included in the processing unit 210.

The sub-processor 231 may perform second data processing while accessing the second memory 300 according to a request received from the processing unit 210. As in the example described above, the processing unit 210 may transmit the first virtual address VA1 or the first physical address PA1 to the input/output unit 230.

When the processing unit 210 transmits the first physical address PA1 to the input/output unit 230, the input/output unit 230 may transmit the first physical address PA1 to the second memory 300. This may correspond to a case where first data processing is performed by the processing unit 210.

When receiving the first virtual address VA1 from the processing unit 210, the input/output unit 230 may perform second data processing on the basis of the first virtual address VA1. For example, the sub-address translation section 232 may generate a second physical address PA2 on the basis of the first virtual address VA1 received from the processing unit 210. The input/output unit 230 may transmit the second physical address PA2 generated by the sub-address translation section 232 to the second memory 300. The input/output unit 230 controls the operation of the second memory 300 on the basis of the second physical address PA2 and the command, and may perform second data processing using the second memory 300.

The input/output unit 230 may perform data processing using an internally generated virtual address. For example, the sub-processor 231 may output a second virtual address VA2. The sub-address translation section 232 may translate the second virtual address VA2 into a second physical address PA2 and transmit the second physical address PA2 to the second memory 300. The input/output unit 230 controls the operation of the second memory 300 on the basis of the second physical address PA2 and the command, and may perform second data processing using the second memory 300.

Mapping data may be managed and shared by the processing unit 210 and the input/output unit 230. The processing unit 210 and the input/output unit 230 may perform data processing using shared mapping data, and may update and share mapping data according to the data processing that is performed.

Since the input/output unit 230 performs a part of data processing using the second memory 300 while providing a data transmission function for the processing unit 210, delay time due to data processing using the second memory 300 may be reduced, and thus, the performance of data processing performed by the data processing device 200 using the second memory 300, which is an external memory, may be improved.

Data processing using the second memory 300 may be performed by the processing unit 210 and the input/output unit 230. To maintain consistency in the data processing, information related to the results of data processing may be shared between the processing unit 210 and the input/output unit 230.

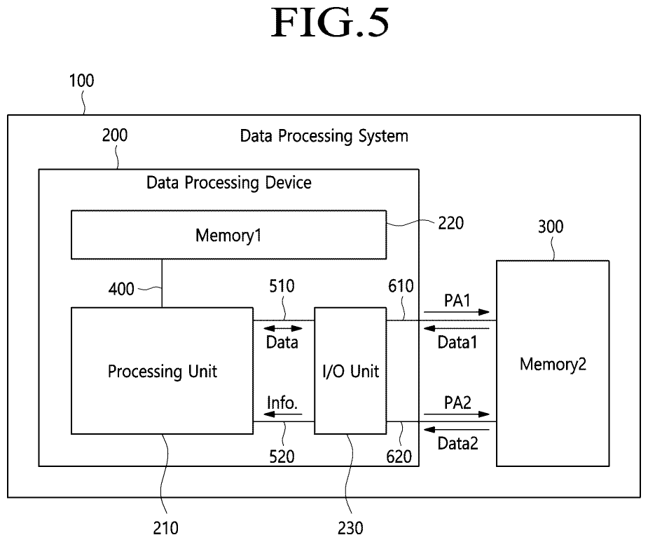

FIG. 5 is a diagram illustrating an example in which a data processing system performs data processing according to embodiments of the present disclosure.

Referring to FIG. 5, in a data processing device 200 of a data processing system 100, a processing unit 210 may perform first data processing while communicating with a first memory 220 through an internal signal line 400.

The processing unit 210 may perform first data processing while transmitting and receiving data to and from a second memory 300 through an input/output unit 230. The processing unit 210 may transmit and receive data for first data processing through the data transmission line 510, which is connected to the input/output unit 230.

For example, the processing unit 210 may transmit a command and a virtual address to the input/output unit 230 through the data transmission line 510.

The input/output unit 230 may transmit data for first data processing, received from the processing unit 210, to the second memory 300 through the first external signal line 610. The input/output unit 230 may receive first result data Data 1 according to first data processing through the first external signal line 610. The input/output unit 230 may transmit the first result data to the processing unit 210 through the data transmission line 510.

The input/output unit 230 may perform second data processing within the input/output unit 230 according to a request from the processing unit 210.

The input/output unit 230 may transmit data for second data processing to the second memory 300 through the second external signal line 620. The input/output unit 230 may perform second data processing using the second memory 300 and obtain second result data Data 2 according to the second data processing. For example, the input/output unit 230 may store the second result data in the second memory 300.

When second data processing is performed by the input/output unit 230 and data stored in the second memory 300 is updated, the input/output unit 230 may provide information on second result data from the second data processing to the processing unit 210.

For example, the input/output unit 230 may transmit the corresponding information to the processing unit 210 through the communication line 520. The input/output unit 230 may transmit, to the processing unit 210, completion information on a task processed in response to receiving a request from the processing unit 210, or may provide, to the processing unit 210, information on an address of the second memory 300, which is updated according to second data processing.

Since the input/output unit 230 performs data processing using the second memory 300 and shares a result according to the data processing with the processing unit 210, the processing unit 210 may perform data processing on the basis of the data processing performed by the input/output unit 230. The processing unit 210 may perform data processing by using the result according to the data processing performed by the input/output unit 230.

In this way, as the input/output unit 230 performs data processing using the second memory 300, which is located outside the data processing device 200, delay in data processing performed by the data processing device 200 using an external memory may be reduced and the performance of data processing may be improved.

In some embodiments, the input/output unit 230 may perform data processing using the first memory 220, which is located inside the data processing device 200, thereby improving data processing performance inside the data processing device 200.

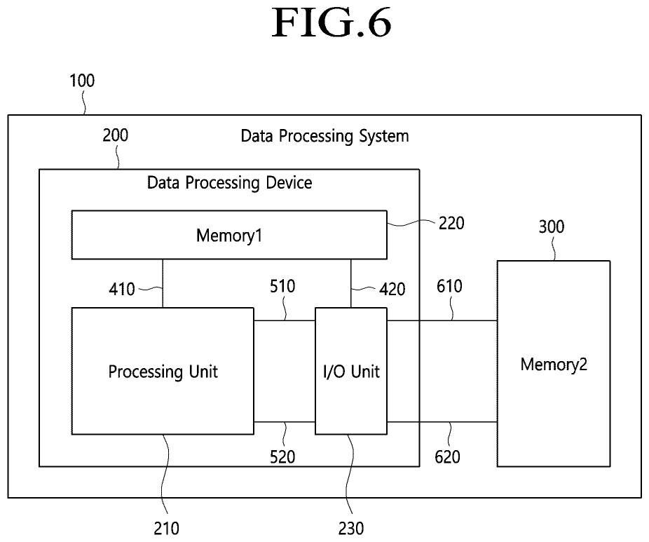

FIG. 6 is a diagram illustrating another example of a configuration of a data processing system according to embodiments of the present disclosure.

Referring to FIG. 6, a data processing system 100 may include a data processing device 200 and a second memory 300 as an external memory. The data processing device 200 may include a processing unit 210, a first memory 220 as an internal memory, and an input/output unit 230.

As in the example described above, the input/output unit 230 may provide a data processing function using a memory. The input/output unit 230 may perform data processing using the second memory 300 or may perform data processing using the first memory 220. Embodiments of the present disclosure also apply when the input/output unit 230 provides only the function of transmitting and receiving data to and from the second memory 300 and performs data processing using the first memory 220.

Data processing using the first memory 220 and the second memory 300 may be performed by the processing unit 210 and the input/output unit 230.

The processing unit 210 may communicate with the first memory 220 through a first internal signal line 410. The processing unit 210 may perform first data processing using the first memory 220 while also transmitting and receiving data to and from the first memory 220 through the first internal signal line 410.

The input/output unit 230 may communicate with the first memory 220 through a second internal signal line 420. The input/output unit 230 may perform second data processing using the first memory 220 while also transmitting and receiving data to and from the first memory 220 through the second internal signal line 420.

The processing unit 210 and the input/output unit 230 may also perform data processing using the second memory 300. A scheme in which the processing unit 210 and the input/output unit 230 perform data processing using the second memory 300 may be similar to the example described above with reference to FIG. 5.

In order to efficiently perform data processing using the second memory 300, which is located outside the data processing device 200, a sub-processor 231 is disposed in the input/output unit 230, and data processing by the input/output unit 230 may be performed.

Since the sub-processor 231 is disposed in the input/output unit 230, data processing using the first memory 220 may be performed by the processing unit 210 and the input/output unit 230, so that the performance of data processing within the data processing device 200 may be improved.

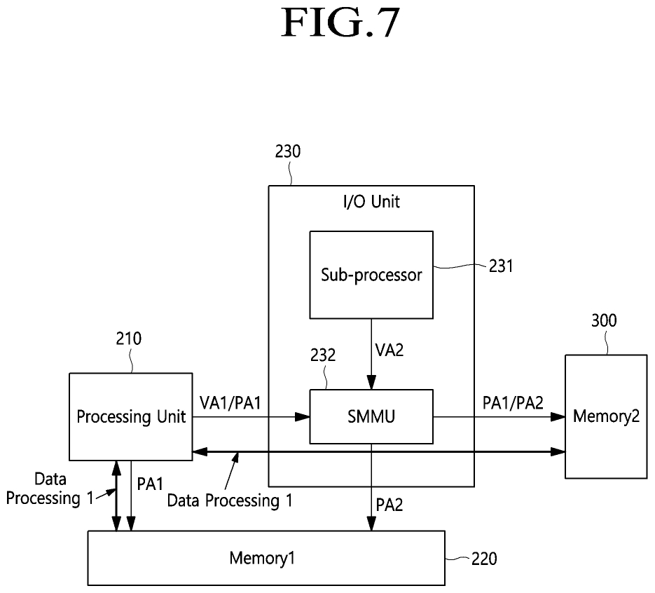

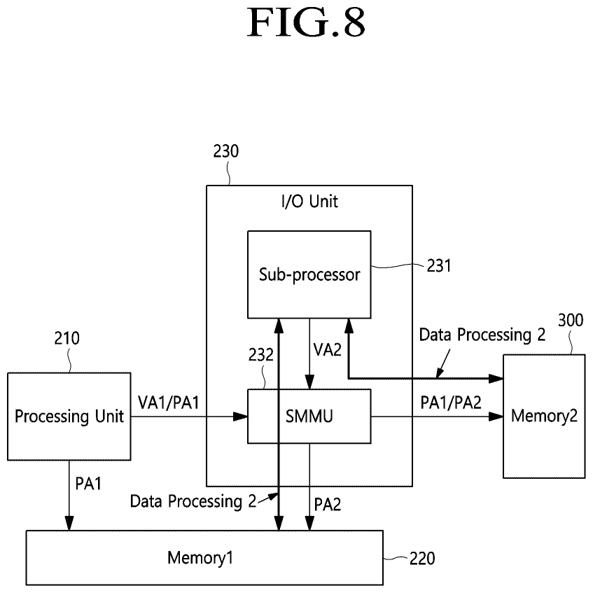

FIG. 7 is a diagram illustrating an example in which a processing unit of a data processing system performs data processing according to embodiments of the present disclosure. FIG. 8 is a diagram illustrating an example in which an input/output unit of a data processing system performs data processing according to embodiments of the present disclosure.

Referring to FIGS. 7 and 8, data processing may be performed by a processing unit 210 and an input/output unit 230 included in a data processing device 200.

For example, in FIG. 7, a processing unit 210 may transmit a first physical address PA1 to a first memory 220 and perform first data processing using the first memory 220. The processing unit 210 may transmit a first physical address PA1 to a second memory 300 through the input/output unit 230 and perform first data processing using the second memory 300.

A scheme in which the processing unit 210 performs first data processing using the first memory 220 and the second memory 300 may be similar to that where a sub-processor 231 is not included in the input/output unit 230.

The processing unit 210 may perform first data processing while communicating with the first memory 220 through a first internal signal line 410, and may perform first data processing while communicating with the second memory 300 through the input/output unit 230 and a first external signal line 610. The first physical address PA1 may be transmitted through the first internal signal line 410. Data and a result related to the first data processing may be transmitted through the first internal signal line 410 also. And the first physical address PA1 and/or the second physical address PA2 may be transmitted through the first external signal line 610. Data and a result related to the second data processing may be transmitted through the first external signal line 610 also.

The input/output unit 230 may perform second data processing using at least one of the first memory 220 or the second memory 300 according to a request of the processing unit 210.

For example, in FIG. 8, a sub-processor 231 of an input/output unit 230 may perform second data processing using a first memory 220.

The sub-processor 231 may output a second virtual address VA2. A sub-address translation section 232 may translate the second virtual address VA2 into a second physical address PA2 and transmit the second physical address PA2 to a first memory 220 through a second internal signal line 420. The second physical address PA2 may be transmitted through the second internal signal line 420. And data and a result of the second data processing may be transmitted through the second internal signal line 420 also.

The sub-processor 231 may perform second data processing using a second memory 300, which is located outside the data processing device 200. Similarly, a second virtual address VA2 outputted by the sub-processor 231 may be translated into a second physical address PA2, and the second physical address PA2 may be transmitted to the second memory 300.

Second data processing using the first memory 220 and the second memory 300 may be performed by the sub-processor 231 and the sub-address translation section 232 included in the input/output unit 230.

A result according to second data processing performed by the input/output unit 230 may be provided to the processing unit 210.

Information on a result from first data processing performed by the processing unit 210 may not be provided to the input/output unit 230, or a part of the result information may be provided to the input/output unit 230.

A result according to data processing between the input/output unit 230 and the processing unit 210 may be shared by transmitting information through a communication line 520 or may be shared using a memory used for data processing. In some case, the data transmission line 510 may be used for sharing the information, or like as above-mentioned the communication line 520 which is different from the data transmission line 510 may be used for sharing the information.

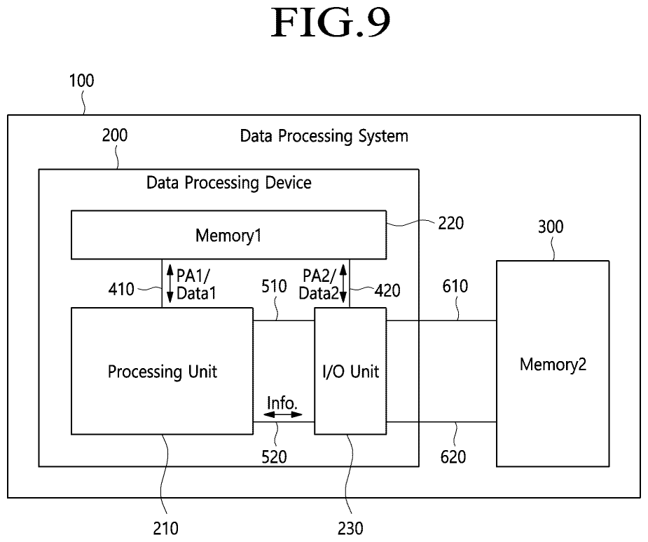

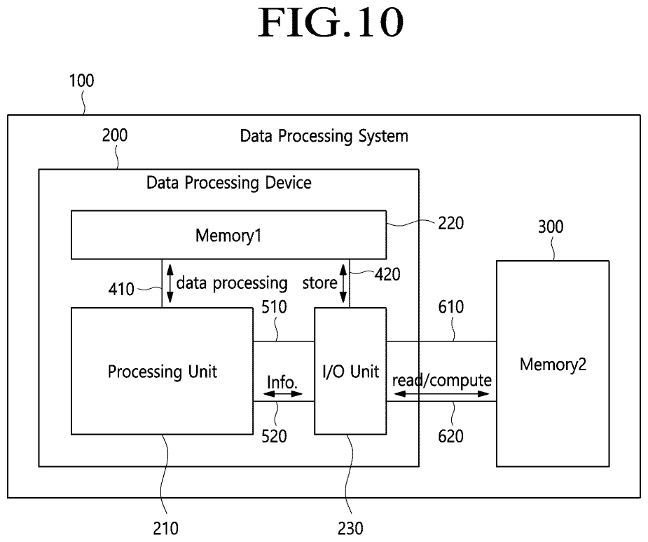

FIG. 9 and FIG. 10 are diagrams illustrating examples of a data processing system according to embodiments of the present disclosure performs data processing.

Referring to FIG. 9, data processing is performed using the first memory 220, which is located inside the data processing device 200 of the data processing system 100.

The processing unit 210 of the data processing device 200 may perform first data processing while communicating with the first memory 220 through the first internal signal line 410. The processing unit 210 may transmit a command and a first physical address PA1 to the first memory 220 through the first internal signal line 410. The processing unit 210 may receive data through the first internal signal line 410 from the first memory 220.

An input/output unit 230 of the data processing device 200 may perform second data processing while communicating with the first memory 220 through a second internal signal line 420. The input/output unit 230 may transmit a command and a second physical address PA2 to the first memory 220 through the second internal signal line 420. The input/output unit 230 may receive data through the second internal signal line 420 from the first memory 220.

The processing unit 210 and the input/output unit 230 may share information, through the communication line 520, on a result according to data processing, and may share an address updated in the first memory 220.

Alternatively, the processing unit 210 and the input/output unit 230 may manage data processing by storing result data in the first memory 220 and sharing result data from the data processing.

For example, the first memory 220 may include a buffer for storing first result data according to first data processing by the processing unit 210 or second result data according to second data processing by the input/output unit 230. When the first memory 220 is an HBM, the first memory 220 may include a logic die and a plurality of memory dies, which are disposed on the logic die. In this case, the above-described buffer may be included in the logic die.

The first memory 220 may store, in the buffer of the first memory 220, at least a part of data regarding a command and an address received from the processing unit 210 or the input/output unit 230 and result data according to data processing.

The processing unit 210 and the input/output unit 230 may read result data and so on stored in the buffer of the first memory 220. Through the buffer of the first memory 220, result data and so on related to data processing may be shared between the processing unit 210 and the input/output unit 230. Even when data processing is performed by each of the processing unit 210 and the input/output unit 230, the efficiency of data processing may be increased while maintaining the consistency of data management.

In some embodiments, the first memory 220 and the second memory 300 facilitate sharing of result data, and data may be shared between the first memory 220 and the second memory 300.

For example, referring to FIG. 10, an input/output unit 230 performs second data processing using a second memory 300 as an example. Compared to a case in which a processing unit 210 performs first data processing using the second memory 300, when the input/output unit 230 performs second data processing using the second memory 300, delay may effectively be reduced according to transmission and reception of data.

The input/output unit 230 may transmit a command, a physical address and so on through a second external signal line 620, and may perform second data processing, such as a calculation, using data stored in the second memory 300.

The input/output unit 230 may store result data according to second data processing performed using the second memory 300 in the second memory 300. The input/output unit 230 may store result data according to second data processing in the first memory 220. The input/output unit 230 may store the result data in the memory area of the first memory 220 or in the buffer described above.

The input/output unit 230 may provide information on a result of second data processing to the processing unit 210 through a communication line 520.

The processing unit 210 may perform first data processing while communicating with a first memory 220 through a first internal signal line 410. When the processing unit 210 performs first data processing using the first memory 220, the processing unit 210 may use result data stored in the first memory 220 according to second data processing performed by the input/output unit 230.

Since the input/output unit 230 may access both the first memory 220 and the second memory 300 and may store, in the internal first memory 220, result data according to second data processing performed through the external second memory 300, the processing unit 210 may perform first data processing using the result data while accessing the internal first memory 220.

Without accessing the second memory 300, which is located outside the data processing device 200, the processing unit 210 may perform first data processing using a result of second data processing by the input/output unit 230. Delay due to access between the processing unit 210 and an external memory may be reduced, and as the processing unit 210 performs first data processing using an internal memory, the efficiency of data processing may be increased.

According to embodiments of the present disclosure described above, since the data processing device 200, which performs data processing using an internal memory and an external memory, provides a data processing function using the input/output unit 230, which performs communication with the external memory, delay time due to access to the external memory may be reduced, and the performance of data processing using the external memory may be improved.

In addition, as the input/output unit 230 performs the function of sub-processing, data processing using the internal memory may be performed together with the processing unit 210. Therefore, the performance of data processing using the internal memory of the data processing device 200 may also be improved.

Although various embodiments of the present disclosure have been described with particular specifics and varying details for illustrative purposes, those skilled in the art will appreciate that various modifications, additions and substitutions may be made based on what is disclosed or illustrated in the present disclosure without departing from the spirit and scope of the present disclosure as defined in the following claims.

What is claimed is:

1. A data processing device comprising:
a first memory;
a processing unit configured to communicate with the first memory through a first signal line, and to perform first data processing using the first memory and an external second memory; and
an input/output unit configured to communicate with the first memory through a second signal line, to transfer data that is transmitted and received between the processing unit and the external second memory, and to perform second data processing using at least one of the first memory or the external second memory.

2. The data processing device according to claim 1, wherein the processing unit comprises:
a processing core configured to control the first data processing;
a first address translation section configured to translate a first virtual address, output by the processing core, into a first physical address; and
a second address translation section configured to receive the first physical address and to transmit the first physical address or the first virtual address corresponding to the first physical address to the input/output unit.

3. The data processing device according to claim 2, wherein the input/output unit comprises:
a sub-processor configured to control the second data processing; and
a sub-address translation section configured to translate a second virtual address, output by the sub-processor, into a second physical address.

4. The data processing device according to claim 3, wherein the input/output unit is bypassed and transmits the first physical address received from the processing unit to the external second memory, or transmits the second physical address translated by the sub-address translation section to at least one of the first memory or the external second memory.

5. The data processing device according to claim 4, wherein the input/output unit transmits the second physical address to the first memory through the second signal line.

6. The data processing device according to claim 4, wherein the input/output unit transmits the first physical address to the external second memory through a first external signal line, and transmits the second physical address to the external second memory through a second external signal line.

7. The data processing device according to claim 4, wherein
the input/output unit transmits the first physical address to the external second memory through an external signal line, and transfers data received from the external second memory to the processing unit, and
the input/output unit transmits the second physical address to the external second memory through the external signal line, and performs the second data processing using data received from the external second memory.

8. The data processing device according to claim 1, wherein the first memory includes a buffer, which stores first result data according to the first data processing or second result data according to the second data processing.

9. The data processing device according to claim 8, wherein at least one of the processing unit or the input/output unit reads at least one of the first result data or the second result data stored in the buffer.

10. The data processing device according to claim 1, wherein the processing unit generates first result data by performing the first data processing using the first memory, and transmits information related to the first result data through a communication line that is electrically connected between the processing unit and the input/output unit.

11. The data processing device according to claim 10, wherein when performing the first data processing using the external second memory, the processing unit transmits and receives data through a data transmission line that is electrically connected between the processing unit and the input/output unit.

12. The data processing device according to claim 10, wherein the input/output unit performs the second data processing using data read from the external second memory, and stores second result data from the second data processing in the first memory.

13. The data processing device according to claim 12, wherein the input/output unit transmits a notification signal to the processing unit through the communication line when storing the second result data in the first memory.

14. A data processing system comprising:
an external memory disposed on a substrate; and
a data processing chip disposed on the substrate, and configured to communicate with the external memory,
the data processing chip comprising:
an internal memory;
a processing unit configured to perform first data processing using the internal memory and the external memory; and
an input/output unit configured to transfer data to be transmitted and received between the processing unit and the external memory, and to perform second data processing using at least one of the internal memory or the external memory.

15. The data processing system according to claim 14, wherein the internal memory communicates with the processing unit through a first internal signal line, and communicates with the input/output unit through a second internal signal line.

16. The data processing system according to claim 14, wherein the input/output unit transfers first data to be transmitted and received between the processing unit and the external memory through a first external signal line, and transmits and receives second data for the second data processing through a second external signal line.

17. The data processing system according to claim 14, wherein the data processing chip further comprises:
a data transmission line, electrically connected between the processing unit and the input/output unit, through which data according to the first data processing is transmitted and received; and
a communication line, electrically connected between the processing unit and the input/output unit, through which a control signal according to the first data processing or the second data processing is transmitted and received.

18. A data processing system comprising:
an external memory disposed on a substrate; and
a data processing chip disposed on the substrate, and configured to communicate with the external memory,
the data processing chip comprising:
an internal memory;
a processing unit configured to communicate with the internal memory, and to perform first data processing using the internal memory and the external memory; and
an input/output unit configured to transfer data, to be transmitted and received between the processing unit and the external memory through a first external signal line, and perform second data processing while transmitting and receiving data to and from the external memory through a second external signal line.

19. The data processing system according to claim 18, wherein the processing unit communicates with the internal memory through a first internal signal line and the input/output unit communicates with the internal memory through a second internal signal line.

20. The data processing system according to claim 19, wherein
when performing the first data processing while transmitting and receiving data using the first internal signal line, the processing unit transmits information related with a result according to the first data processing to the input/output unit through a communication line, which is electrically connected between the processing unit and the input/output unit, and
when performing the second data processing while transmitting and receiving data using the second external signal line, the input/output unit transmits information related with the second data processing to the processing unit through the communication line.
